(19) United States
(12) Patent Application Publication
(10) Pub. No.: US 2023/0292037 A1
(43) Pub. Date: Sep. 14, 2023

(54) COAXIAL HORN

(71) Applicant: DONGGUAN FUXIN ELECTRONIC CO., LTD., Dongguan, Guangdong (CN)

(72) Inventors: Weidong XU, Dongguan, Guangdong (CN); Hui CHEN, Dongguan, Guangdong (CN)

(21) Appl. No.: 17/610,692

(22) PCT Filed: Dec. 11, 2020
(86) PCT No.: PCT/CN2020/135776

§ 371 Date: Nov. 11, 2021

(30) Foreign Application Priority Data
Dec. 1, 2020 (CN) 202011398885.7

(51) Int. Cl. H04R 1/24; H04R 3/00; H04R 9/06; H04R 9/04

(52) U.S. Cl. CPC H04R 1/24; H04R 3/00; H04R 9/06; H04R 9/045

(57) ABSTRACT

The present invention provides a coaxial horn, the coaxial horn includes a woofer and a tweeter, wherein the tweeter is located on the upper side of the woofer and disposed on the same axis as the woofer; the woofer includes a first protective cover and a circuit board; a first conductive module is arranged on the first protective cover; the lower end of the first conductive module is connected to the circuit board; the tweeter comprises a first support and a first voice coil; a second conductive module is arranged on the first support; a connecting wire of the first voice coil is connected to the upper end of the second conductive module; and the upper end of the first conductive module is connected to the lower end of the second conductive module.

### TECHNICAL FIELD

The present invention relates to the field of horns, in particular to a coaxial horn.

### BACKGROUND ART

A coaxial horn, also referred as a coaxial speaker, includes a tweeter in addition to a mid-bass speaker, which are arranged on the same axis and responsible for replaying a treble and a mid-bass respectively. The coaxial horn has the advantage of significantly improving the bandwidth of a separate speaker.

Presently, a general structure adopted by the coaxial horn are as follow: a tweeter is superimposed in front of a woofer, or the woofer is superimposed in front of the tweeter, to form a pyramid structure. For example, patent No. 201820174530.1 discloses a coaxial horn and a speaker, wherein the coaxial horn comprises a mid-bass horn, a mid-bass sonic tube used to propagate sound waves of the mid-bass horn, a tweeter arranged in an inner cavity of the mid-bass sonic tube, and a supporting structure used to support the tweeter and connected to an inner wall of the mid-bass sonic tube; and a long axis of the tweeter is collinear with a long axis of the mid-bass horn. The mid-bass sonic tube is arranged in front of the mid-bass horn and used to propagate sound waves emitted by the mid-bass horn. An inner diameter of the mid-bass sonic tube is large enough so that the tweeter coaxial with the mid-bass horn is arranged in the mid-bass sonic tube. This way, a single-point sound production effect can be achieved. Such horn is suitable for large-size speaker equipment such as a car speaker due to its large size and easy wiring. However, for small-sized equipment such as earphones, it is difficult to connect a woofer and a tweeter with a conventional wiring mode during the connection and assembly process of the woofer and the tweeter due to small sizes of the woofer and the tweeter, resulting in failure of mass production and major defects.

### SUMMARY OF THE INVENTION

In view of the above problems, the present invention provides a coaxial horn. According to the coaxial horn, a tweeter and a woofer are arranged on the same axis and used to replay respective frequency bands respectively, such that the bandwidth of the coaxial speaker can be significantly improved. In addition, the tweeter and the woofer are connected in a welding mode, so that batch production can be conducted to produce small-size equipment.

In order to achieve the above objective, the present invention solves the problem through the following technical solutions:

A coaxial horn, comprising a woofer and a tweeter, wherein the tweeter is located on the upper side of the woofer and disposed on the same axis as the woofer; the woofer comprises a first protective cover and a circuit board; a first conductive module is arranged on the first protective cover; the lower end of the first conductive module is connected to the circuit board; the tweeter comprises a first support and a first voice coil; a second conductive module is arranged on the first support; a connecting wire of the first voice coil is connected to the lower end of the second conductive module; and the upper end of the first conductive module is connected to the lower end of the second conductive module.

Specifically, the woofer further comprises a second support, a first U iron, a first magnet, a first washer, a second voice coil, and a first diaphragm; a third conductive module is arranged on the second support; a connecting wire of the second voice coil is connected to the upper end of the third conductive module; and the lower end of the third conductive module is connected to the circuit board.

Specifically, the third conductive module and the second support are integrally formed and connected; a first bonding pad and a second bonding pad are connected to the upper end and the lower end of the third conductive module respectively; a connecting wire of the second voice coil is welded to the first bonding pad; and the second bonding pad is welded to the circuit board.

Specifically, the tweeter further comprises a second U iron, a tuning net, a second magnet, a second washer, a second protective cover, and a second diaphragm.

Specifically, the second conductive module and the first support are integrally formed and connected; a third bonding pad and a fourth bonding pad are connected to the upper end and the lower end of the second conductive module respectively; and a connecting wire of the first voice coil is welded to the third bonding pad.

Specifically, the first conductive module and the first protective cover are integrally formed and connected; a fifth bonding pad is welded to the upper end of the first conductive module; and the fourth bonding pad is welded to the fifth bonding pad.

Specifically, the first conductive module is a flexible circuit board; an avoidance slot is formed in the outer side of the first protective cover; the flexible circuit board is attached to the inside of the avoidance slot; and the fourth bonding pad is welded to the upper end of the flexible circuit board.

Specifically, the first protective cover and the first support are integrally formed and connected; the first conductive module and the second conductive module are integrally formed and connected; the first conductive module and the second conductive module are connected to form a fourth conductive module; a sixth bonding pad is connected to the upper end of the fourth conductive module; a connecting wire of the first voice coil is welded to the sixth bonding pad; and the lower end of the fourth conductive module is welded to the circuit board.

The present invention has the following benefits:
1. according to the coaxial horn of the present invention, the tweeter and the woofer are arranged on the same axis and used to replay respective frequency bands respectively, thus improving the bandwidth of the coaxial horn significantly. As a result, a frequency reception range of 20-20 kHz discernable for human ears can be produced by just one horn; and
2. the coaxial horn of the present invention is suitable for small-sized horn equipment, such as earphones; the tweeter and the woofer are designed into a weldable structure, and the electrical connection between the tweeter and the woofer is achieved by welding, which can solve the problem of difficulties in wiring due to a small size of a horn in the prior art.

### BRIEF DESCRIPTION OF THE DRAWINGS

FIG. 1 is a three-dimensional structure diagram of a coaxial horn in Embodiment 1.

FIG. 2 is a bottom view of the coaxial horn in Embodiment 1.

FIG. 3 is a sectional view of a section A-A in FIG. 2.

FIG. 4 is an exploded view of the coaxial horn in Embodiment 1.

FIG. 5 is a schematic structural diagram of a first protective cover and a first conductive module in Embodiment 1.

FIG. 6 is a schematic structural diagram of a first support and a second conductive module in Embodiment 1.

FIG. 7 is a schematic structural diagram of a second support and a third conductive module in Embodiment 1.

FIG. 8 is a schematic structural diagram of the first conductive module, the second conductive module, the third conductive module, a circuit board, a second voice coil and a first voice coil in Embodiment 1.

FIG. 9 is an exploded view of a coaxial horn in Embodiment 2.

FIG. 10 is a schematic structural diagram of a first protective cover, a first support and a fourth conductive module in Embodiment 2.

FIG. 11 is a schematic structural diagram of a third conductive module, a fourth conductive module, a circuit board, a second voice coil and a first voice coil in Embodiment 2.

FIG. 12 is a schematic structural diagram of a first protective cover and a first conductive module in Embodiment 3.

FIG. 13 is a frequency response curve diagram of Embodiment 1 and Comparative Example 1.

Reference symbols represent the following components: 1—woofer; 11—first protective cover; 111—avoidance slot; 12—circuit board; 13—second support; 14—first U iron; 15—first magnet; 16—first washer; 17—second voice coil; 18—first diaphragm; 2—tweeter; 21—first support; 22—first voice coil; 23—second U iron; 24—toning net; 25—second magnet; 26—second washer; 27—second protective cover; 28—second diaphragm; 3—first conductive module; 31—fifth bonding pad; 4—second conductive module; 41—third bonding pad; 42—fourth bonding pad; 5—third conductive module; 51—first bonding pad; 52—second bonding pad; 6—fourth conductive module; 61—sixth bonding pad.

### DETAILED DESCRIPTIONS OF THE PREFERRED EMBODIMENTS

The present invention will be further explained below in conjunction with the embodiments and the accompanying drawings, but the embodiments of the present invention are not limited to the disclosure.

### Embodiment 1

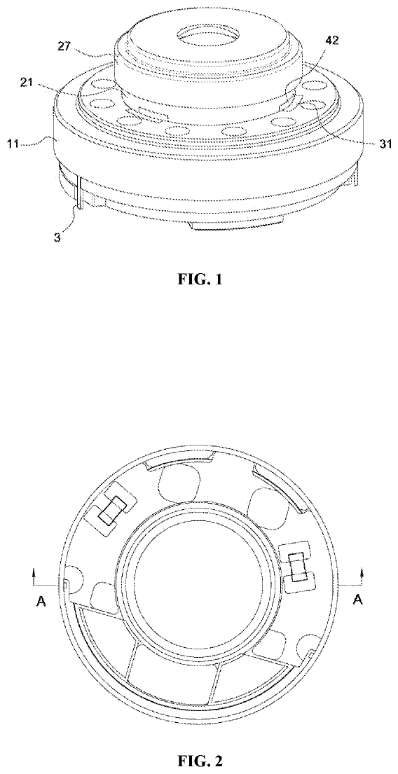

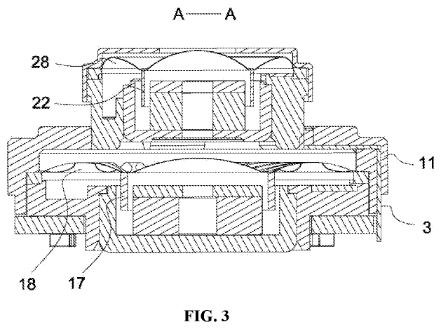

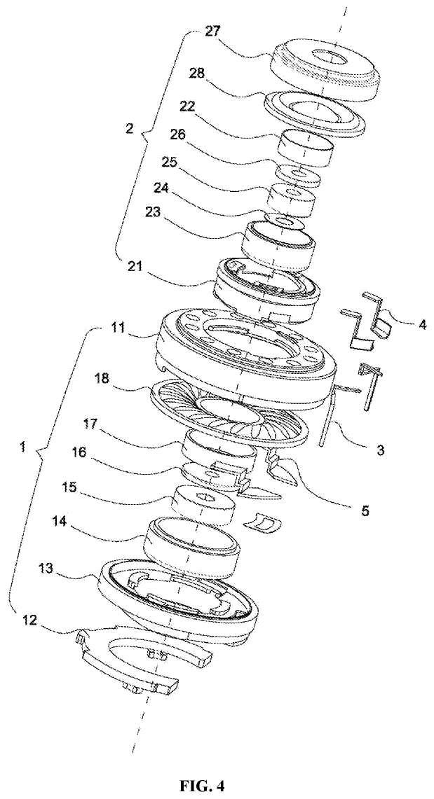

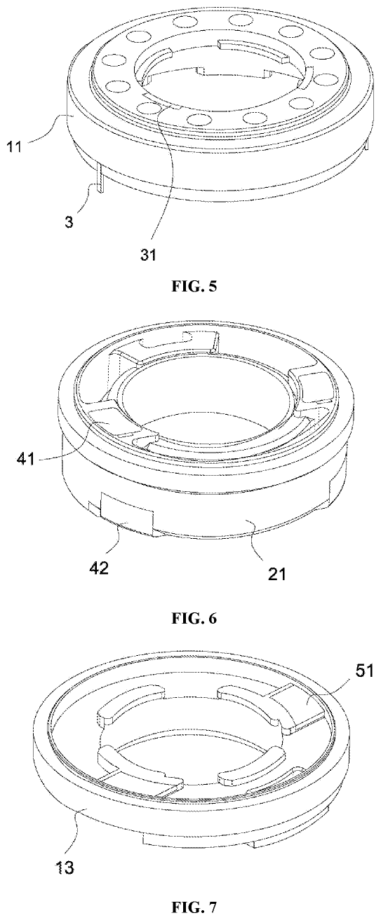

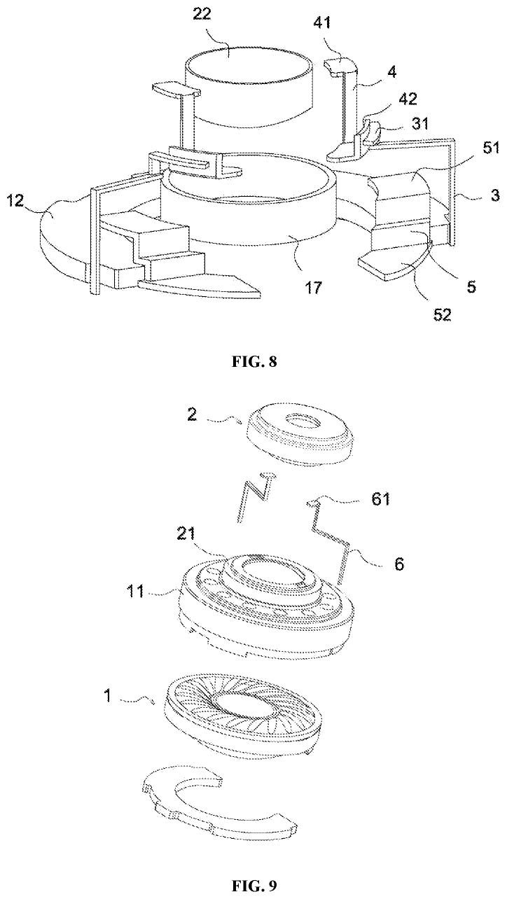

Referring to FIGS. 1 to 8, a coaxial horn comprises a woofer 1 and a tweeter 2, wherein the tweeter 2 is located on the upper side of the woofer 1 and disposed on the same axis as the woofer 1, wherein a dotted line in FIG. 4 is the axis; the woofer 1 comprises a first protective cover 11, a circuit board 12, a second support 13, a first U iron 14, a first magnet 15, a first washer 16, a second voice coil 17, and a first diaphragm 18; the circuit board 12 is fixed at the bottom of the second support 13; the first U iron 14 is fixed on the inner side of the second support 13; a section of the first U iron 14 is of a U-shaped structure, and an accommodating groove is formed inside the first U iron 14; the first magnet 15 and the first washer 16 are located in the middle of the accommodating groove of the first U iron 14; the second voice coil 17 sleeves the first magnet 15 and the first washer 16; and the upper end of the second voice coil 17 is connected to the bottom of the first diaphragm 18. The woofer 1 is responsible for replaying a mid-bass, so the first diaphragm 18 requires a small vibration frequency and a large vibration amplitude. Therefore, the first diaphragm 18 has a relatively large thickness and a relatively caliber. After an audio current is introduced to the second voice coil 17, the second voice coil 17 generates an alternating magnetic field under the action of the current, and the first magnet 15 also generates a constant magnetic field with the same size and direction. Since the magnitude and direction of the magnetic field generated by the second voice coil 17 constantly change with the change of the audio current, the interaction of the two magnetic fields makes the second voice coil 17 move in a direction perpendicular to the direction of the current in the second voice coil 17. Since the second voice coil 17 is connected to the first diaphragm 18, the first diaphragm 18 is driven to vibrate, and the first diaphragm 18 causes air vibration to send out medium and low frequency sound signals.

In the woofer 1, a third conductive module 5 is arranged on the second support 13. The third conductive module 5 is a metal conductive strip. In the production process, the metal conductive strip is first placed in a mold. After injection molding, the metal conductive strip is embedded in the second support 13. That is, the third conductive module 5 and the second support 13 are integrated and connected by injection molding. After the third conductive module 5 is stamped and formed during the manufacturing and molding process, a first bonding pad 51 and a second bonding pad 52 are connected to the upper and lower ends of the third conductive module 5 respectively. A connecting wire of the second voice coil 17 is welded to the first bonding pad 51, and the second bonding pad 52 is welded to the circuit board 12.

The tweeter 2 comprises a first support 21, a first voice coil 22, a second U iron 23, a toning net 24, a second magnet 25, a second washer 26, a second protective cover 27 and a second diaphragm 28; the second U iron 23 is fixed on the inner side of the second support 13; a section of the second U iron 23 is of a U-shaped structure, and an accommodating groove is formed inside the second U iron 23; the second magnet 25 and the second washer 26 are located in the middle of the accommodating groove of the second U iron 23; the first voice coil 22 sleeves the second magnet 25 and the second washer 26; and the upper end of the first voice coil 22 is connected to the bottom of the second diaphragm 28. The tweeter 2 is responsible for replaying a treble, so the second diaphragm 28 requires a small vibration frequency and a large vibration amplitude. Therefore, the second diaphragm 28 has a relatively large thickness and a relatively caliber. After an audio current is introduced into the first voice coil 22, the first voice coil 22 generates an alternating magnetic field under the action of the current, and the second magnet 25 also generates a constant magnetic field with the same size and direction. Since the magnitude and direction of the magnetic field generated by the first voice coil 22 constantly change with the change of the audio current, the interaction of the two magnetic fields makes the first voice coil 22 move in a direction perpendicular to the direction of the current in the first voice coil 22. Since the first voice coil 22 is connected to the second diaphragm 28, the second diaphragm 28 is driven to vibrate, and the second diaphragm 28 causes air vibration to send out high-frequency sound signals.

In the tweeter 2, a second conductive module 4 is a metal conductive strip. In the production process, the metal conductive strip is first placed in a mold. After injection molding, the metal conductive strip is embedded in the first support 21. That is, the second conductive module 4 and the first support 21 are integrated and connected by injection molding. After the second conductive module 4 is stamped and formed during the manufacturing process, a third bonding pad 41 and a fourth bonding pad 42 are connected to the upper and lower ends of the second conductive module 4 respectively. A connecting wire of the first voice coil 22 is welded to the third bonding pad 41.

In order to establish the electrical connection between the woofer 1 and the tweeter 2, a first conductive module 3 is arranged on the first protective cover 11. The first conductive module 3 is a metal conductive strip. In the production process, the metal conductive strip is first placed in a mold. After injection molding, the first conductive module 3 and the first protective cover 11 are integrated and connected by injection molding. In addition, a fifth bonding pad is further formed on the upper end of the bent first conductive module 3. The fourth bonding pad 42 is welded to the fifth bonding pad 31. The lower end of the first conductive module 3 is connected to the circuit board 12. A second conductive module 4 is arranged on the first support 21. A connecting wire of the first voice coil 22 is welded to the upper end of the second conductive module 4. The upper end of the first conductive module 3 is connected to the lower end of the second conductive module 4.

In the above scheme, the tweeter 2 and the woofer 1 are designed as weldable structure, and the electrical connection between the tweeter 2 and the woofer 1 is established by welding, which can solve the problem of difficulty in wiring due to the small size of a horn in the prior art, thereby enables mass production.

### Comparative Example 1

An ordinary woofer is taken as Comparative Example 1.

Testing: a performance comparison test is performed between the coaxial horn of Embodiment 1 and the ordinary woofer of Comparative Example 1, and the test result is shown in FIG. 13. As can be obviously seen from the frequency response curve in FIG. 13, a frequency of the coaxial horn of Embodiment 1 can be increased by more than 10 db at high frequencies, and the effective bandwidth extends to 30 kHz, which indicates that the coaxial horn of the present application can significantly improve the problem of poor high-frequency signals of the ordinary woofer.

### Embodiment 2

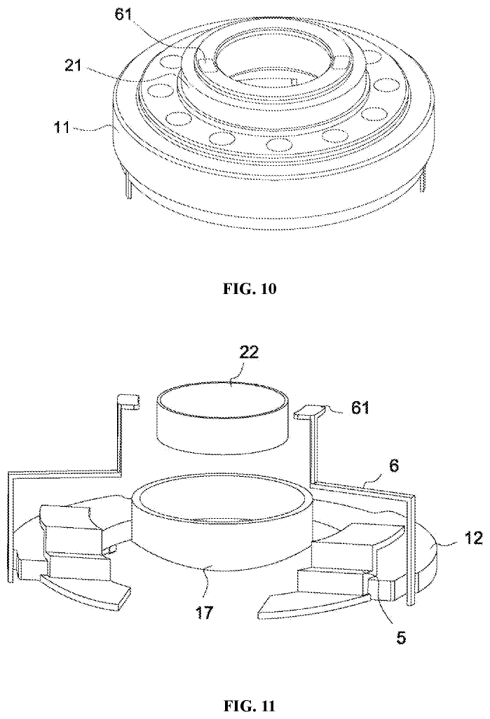

Referring to FIGS. 9 to 11: a coaxial horn comprises a woofer 1 and a tweeter 2, wherein the tweeter 2 is located on the upper side of the woofer 1 and disposed on the same axis as the woofer 1, wherein a dotted line in FIG. 4 is the axis; the woofer 1 comprises a first protective cover 11, a circuit board 12, a second support 13, a first U iron 14, a first magnet 15, a first washer 16, a second voice coil 17, and a first diaphragm 18; the circuit board 12 is fixed at the bottom of the second support 13; the first U iron 14 is fixed on the inner side of the second support 13; a section of the first U iron 14 is of a U-shaped structure, and an accommodating groove is formed inside the first U iron 14; the first magnet 15 and the first washer 16 are located in the middle of the accommodating groove of the first U iron 14; the second voice coil 17 sleeves the first magnet 15 and the first washer 16; and the upper end of the second voice coil 17 is connected to the bottom of the first diaphragm 18. The woofer 1 is responsible for replaying a mid-bass, so the first diaphragm 18 requires a small vibration frequency and a large vibration amplitude. Therefore, the first diaphragm 18 has a relatively large thickness and a relatively caliber. After an audio current is introduced to the second voice coil 17, the second voice coil 17 generates an alternating magnetic field under the action of the current, and the first magnet 15 also generates a constant magnetic field with the same size and direction. Since the magnitude and direction of the magnetic field generated by the second voice coil 17 constantly change with the change of the audio current, the interaction of the two magnetic fields makes the second voice coil 17 move in a direction perpendicular to the direction of the current in the second voice coil 17. Since the second voice coil 17 is connected to the first diaphragm 18, the first diaphragm 18 is driven to vibrate, and the first diaphragm 18 causes air vibration to send out medium- and low-frequency sound signals.

In the woofer 1, a third conductive module 5 is arranged on the second support 13. The third conductive module 5 is a metal conductive strip. In the production process, the metal conductive strip is first placed in a mold. After injection molding, the metal conductive strip is embedded in the second support 13. That is, the third conductive module 5 and the second support 13 are integrated and connected by injection molding. After the third conductive module 5 is stamped and formed during the manufacturing and molding process, a first bonding pad 51 and a second bonding pad 52 are connected to the upper and lower ends of the third conductive module 5 respectively. A connecting wire of the second voice coil 17 is welded to the first bonding pad 51, and the second bonding pad 52 is welded to the circuit board 12.

The tweeter 2 comprises a first support 21, a first voice coil 22, a second U iron 23, a toning net 24, a second magnet 25, a second washer 26, a second protective cover 27 and a second diaphragm 28; the second U iron 23 is fixed on the inner side of the second support 13; a section of the second U iron 23 is of a U-shaped structure, and an accommodating groove is formed inside the second U iron 23; the second magnet 25 and the second washer 26 are located in the middle of the accommodating groove of the second U iron 23; the first voice coil 22 sleeves the second magnet 25 and the second washer 26; and the upper end of the first voice coil 22 is connected to the bottom of the second diaphragm 28. The tweeter 2 is responsible for replaying a treble, so the second diaphragm 28 requires a small vibration frequency and a large vibration amplitude. Therefore, the second diaphragm 28 has a relatively large thickness and a relatively caliber. After an audio current is introduced into the first voice coil 22, the first voice coil 22 generates an alternating magnetic field under the action of the current, and the second magnet 25 also generates a constant magnetic field with the same size and direction. Since the magnitude and direction of the magnetic field generated by the first voice coil 22 constantly change with the change of the audio current, the interaction of the two magnetic fields makes the first voice coil 22 move in a direction perpendicular to the direction of the current in the first voice coil 22. Since the first voice coil 22 is connected to the second diaphragm 28, the second diaphragm 28 is driven to vibrate, and the second diaphragm 28 causes air vibration to send out high-frequency sound signals.

A first protective cover 11 and a first support 21 are integrally formed and connected. In this embodiment, the first conductive module 3 and the second conductive module 4 as shown in Embodiment 1 are canceled. Alternatively, a fourth conductive module 6 is arranged on the first protective cover 11 and the first support 21 which are integrally formed. Similarly, the fourth conductive module 6 is a metal conductive strip, which is embedded inside the first protective cover 11 and the first support 21 by injection molding. In addition, a sixth bonding pad 61 is connected to the upper end of the fourth conductive module 6. A connecting wire of the first voice coil 22 is welded to a sixth bonding pad 61. The lower end of the fourth conductive module 6 is welded to a circuit board 12. A woofer 1 and a tweeter 2 are electrically connected through the fourth conductive module 6.

### Embodiment 3

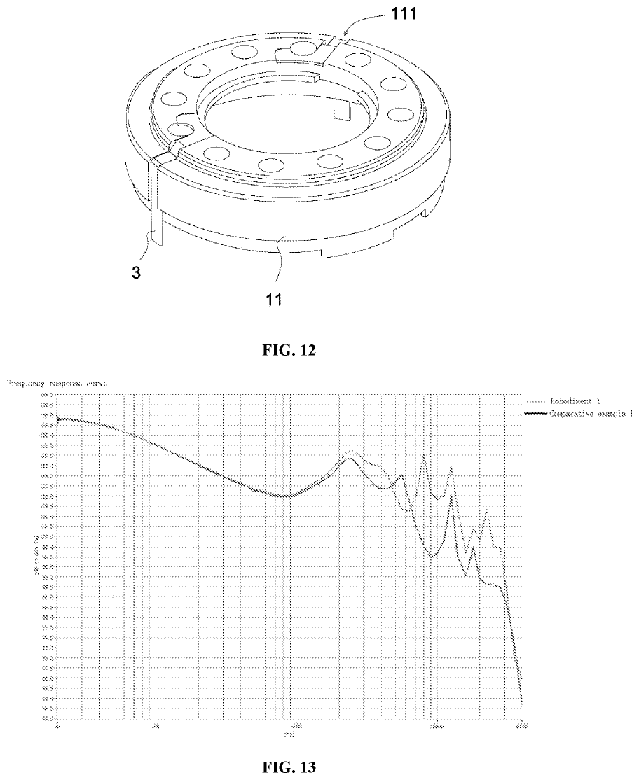

Referring to FIG. 12: a coaxial horn comprises a woofer 1 and a tweeter 2, wherein the tweeter 2 is located on the upper side of the woofer 1 and disposed on the same axis as the woofer 1, wherein a dotted line in FIG. 4 is the axis; the woofer 1 comprises a first protective cover 11, a circuit board 12, a second support 13, a first U iron 14, a first magnet 15, a first washer 16, a second voice coil 17, and a first diaphragm 18; the circuit board 12 is fixed at the bottom of the second support 13; the first U iron 14 is fixed on the inner side of the second support 13; a section of the first U iron 14 is of a U-shaped structure, and an accommodating groove is formed inside the first U iron 14; the first magnet 15 and the first washer 16 are located in the middle of the accommodating groove of the first U iron 14; the second voice coil 17 sleeves the first magnet 15 and the first washer 16; and the upper end of the second voice coil 17 is connected to the bottom of the first diaphragm 18. The woofer 1 is responsible for replaying a mid-bass, so the first diaphragm 18 requires a small vibration frequency and a large vibration amplitude. Therefore, the first diaphragm 18 has a relatively large thickness and a relatively caliber. After an audio current is introduced to the second voice coil 17, the second voice coil 17 generates an alternating magnetic field under the action of the current, and the first magnet 15 also generates a constant magnetic field with the same size and direction. Since the magnitude and direction of the magnetic field generated by the second voice coil 17 constantly change with the change of the audio current, the interaction of the two magnetic fields makes the second voice coil 17 move in a direction perpendicular to the direction of the current in the second voice coil 17. Since the second voice coil 17 is connected to the first diaphragm 18, the first diaphragm 18 is driven to vibrate, and the first diaphragm 18 causes air vibration to send out medium- and low-frequency sound signals.

In the woofer 1, a third conductive module 5 is arranged on the second support 13. The third conductive module 5 is a metal conductive strip. In the production process, the metal conductive strip is first placed in a mold. After injection molding, the metal conductive strip is embedded in the second support 13. That is, the third conductive module 5 and the second support 13 are integrated and connected by injection molding. After the third conductive module 5 is stamped and formed during the manufacturing and molding process, a first bonding pad 51 and a second bonding pad 52 are connected to the upper and lower ends of the third conductive module 5 respectively. A connecting wire of the second voice coil 17 is welded to the first bonding pad 51, and the second bonding pad 52 is welded to the circuit board 12.

The tweeter 2 comprises a first support 21, a first voice coil 22, a second U iron 23, a toning net 24, a second magnet 25, a second washer 26, a second protective cover 27 and a second diaphragm 28; the second U iron 23 is fixed on the inner side of the second support 13; a section of the second U iron 23 is of a U-shaped structure, and an accommodating groove is formed inside the second U iron 23; the second magnet 25 and the second washer 26 are located in the middle of the accommodating groove of the second U iron 23; the first voice coil 22 sleeves the second magnet 25 and the second washer 26; and the upper end of the first voice coil 22 is connected to the bottom of the second diaphragm 28. The tweeter 2 is responsible for replaying a treble, so the second diaphragm 28 requires a small vibration frequency and a large vibration amplitude. Therefore, the second diaphragm 28 has a relatively large thickness and a relatively caliber. After an audio current is introduced into the first voice coil 22, the first voice coil 22 generates an alternating magnetic field under the action of the current, and the second magnet 25 also generates a constant magnetic field with the same size and direction. Since the magnitude and direction of the magnetic field generated by the first voice coil 22 constantly change with the change of the audio current, the interaction of the two magnetic fields makes the first voice coil 22 move in a direction perpendicular to the direction of the current in the first voice coil 22. Since the first voice coil 22 is connected to the second diaphragm 28, the second diaphragm 28 is driven to vibrate, and the second diaphragm 28 causes air vibration to send out high-frequency sound signals.

In the tweeter 2, a second conductive module 4 is a metal conductive strip. In the production process, the metal conductive strip is first placed in a mold. After injection molding, the metal conductive strip is embedded in the first support 21. That is, the second conductive module 4 and the first support 21 are integrated and connected by injection molding. After the second conductive module 4 is stamped and formed during the manufacturing process, a third bonding pad 41 and a fourth bonding pad 42 are connected to the upper and lower ends of the second conductive module 4 respectively. A connecting wire of the first voice coil 22 is welded to the third bonding pad 41.

In order to realize the electrical connection between a woofer 1 and a tweeter 2, a first conductive module 3 is arranged on a first protective cover 11. The first conductive module 3 is a flexible circuit board. An avoidance slot 111 is formed in the outer side of the first protective cover 11. The flexible circuit board is attached to the inside of the avoidance slot 111, and a fourth bonding pad 42 is welded to the upper end of the flexible circuit board.

The above-mentioned embodiments only express the three implementations of the present invention, and the description is relatively specific and detailed, but it should not be understood as a limitation to the patent scope of the present invention. It should be pointed out that for those of ordinary skill in the art, without departing from the concept of the present invention, several modifications and improvements can be made, and these all fall within the protection scope of the present invention. Therefore, the protection scope of the patent of the present invention should be subject to the appended claims.

1. A coaxial horn, comprising a woofer (1) and a tweeter (2), wherein the tweeter (2) is located on an upper side of the woofer (1) and disposed on the same axis as the woofer (1); wherein the woofer (1) further comprising a first protective cover (11) and a circuit board (12); wherein a first conductive module (3) is arranged on the first protective cover (11); wherein a lower end of the first conductive module (3) is connected to the circuit board (12); wherein the tweeter (2) further comprising a first support (21) and a first voice coil (22); wherein a second conductive module (4) is arranged on the first support (21); wherein a connecting wire of the first voice coil (22) is connected to a lower end of the second conductive module (4); and wherein an upper end of the first conductive module (3) is connected to the lower end of the second conductive module (4).

2. The coaxial horn according to claim 1, wherein the woofer (1) further comprising a second support (13), a first U iron (14), a first magnet (15), a first washer (16), a second voice coil (17), and a first diaphragm (18); wherein a third conductive module (5) is arranged on the second support (13); wherein a connecting wire of the second voice coil (17) is connected to an upper end of the third conductive module (5); and wherein a lower end of the third conductive module (5) is connected to the circuit board (12).

3. The coaxial horn according to claim 2, wherein the third conductive module (5) and the second support (13) are integrally formed and connected; wherein a first bonding pad (51) and a second bonding pad (52) are connected to an upper end and a lower end of the third conductive module (5) respectively; wherein a connecting wire of the second voice coil (14) is welded to the first bonding pad (51); and the second bonding pad (52) is welded to the circuit board (12).

4. The coaxial horn according to claim 1, wherein the tweeter (2) further comprising a second U iron (23), a tuning net (24), a second magnet (25), a second washer (26), a second protective cover (27), and a second diaphragm (28).

5. The coaxial horn according to claim 1, wherein the second conductive module (4) and the first support (21) are integrally formed and connected; wherein a third bonding pad (41) and a fourth bonding pad (42) are connected to an upper end and a lower end of the second conductive module (4) respectively; and wherein a connecting wire of the first voice coil (22) is welded to the third bonding pad (41).

6. The coaxial horn according to claim 5, wherein the first conductive module (3) and the first protective cover (11) are integrally formed and connected; wherein a fifth bonding pad (31) is welded to the upper end of the first conductive module (3); and wherein the fourth bonding pad (42) is welded to the fifth bonding pad (31).

7. The coaxial horn according to claim 5, wherein the first conductive module (3) is a flexible circuit board; wherein an avoidance slot (111) is formed in an outer side of the first protective cover (11); wherein the flexible circuit board is attached to the inside of the avoidance slot (111); and wherein the fourth bonding pad (42) is welded to an upper end of the flexible circuit board.

8. The coaxial horn according to claim 1, wherein the first protective cover (11) and the first support (21) are integrally formed and connected; wherein the first conductive module (3) and the second conductive module (4) are integrally formed and connected; wherein the first conductive module (3) and the second conductive module (4) are connected to form a fourth conductive module (6); wherein a sixth bonding pad (61) is connected to an upper end of the fourth conductive module (6); wherein a connecting wire of the first voice coil (22) is welded to the sixth bonding pad (61); and wherein a lower end of the fourth conductive module (6) is welded to the circuit board (12).
